(19) United States
(12) Patent Application Publication
(10) Pub. No.: US 2026/0332657 A1
(43) Pub. Date: Oct. 22, 2026

(54) METHOD AND DEVICE FOR PROVIDING ADAPTIVE SPLIT RENDERING IN COMMUNICATION SYSTEM

(71) Applicant: Samsung Electronics Co., Ltd., Gyeonggi-do (KR)

(72) Inventors: Sungryeul RHYU, Gyeonggi-do (KR); Hyunkoo YANG, Gyeonggi-do (KR); Hakju LEE, Gyeonggi-do (KR)

(21) Appl. No.: 19/122,935

(22) PCT Filed: Oct. 27, 2023
(86) PCT No.: PCT/KR2023/016937

§ 371 Date: Apr. 21, 2025

(30) Foreign Application Priority Data
Oct. 28, 2022 (KR) 10-2022-0141709

(51) Int. Cl. H04L 65/65; H04L 65/1108; H04L 65/75

(52) U.S. Cl. CPC H04L 65/65; H04L 65/1108; H04L 65/75

(57) ABSTRACT

The present disclosure provides a method performed by a terminal in a communication system, the method comprising the operations of: receiving, from an application provider (AP) device, an adaptive split rendering policy (ASR policy) applied by the AP device; transmitting a service access information (SAI) request for requesting SAT to an application function (AF) device on the basis of the ASR policy; in response to the SAI request, receiving, from the AF device, an MPE URL response including a media play entry (MPE); transmitting, to an adaptive split rendering signaling server (ASRSS), an MPE request for requesting the MPE on the basis of the MPE URL response; and in response to the MPE request, receiving, from the ASRSS, an adaptive split rendering media play entry (ASRMPE) including a media presentation description (MPD) for web real-time communication (WebRTC) and a session description protocol (SDP) for 5-th generation media streaming (5GMS) communication.

### TECHNICAL FIELD

The disclosure relates to a method and device for providing adaptive split rendering in a communication system.

### BACKGROUND ART

In order to meet the demand for wireless data traffic soaring since the 4G communication system came to the market, there are ongoing efforts to develop enhanced 5G communication systems or pre-5G communication systems. For the reasons, the 5G communication system or pre-5G communication system is called the beyond 4G network communication system or post long-term evolution (LTE) system.

For higher data transmit rates, 5G communication systems are considered to be implemented on ultra-high frequency bands (mmWave), such as, e.g., 60 GHz. To mitigate pathloss on the ultra-high frequency band and increase the reach of radio waves, the following techniques are taken into account for the 5G communication system, beamforming, massive multi-input multi-output (MIMO), full dimensional MIMO (FD-MIMO), array antenna, analog beamforming, and large scale antenna.

Also being developed are various technologies for the 5G communication system to have an enhanced network, such as evolved or advanced small cell, cloud radio access network (cloud RAN), ultra-dense network, device-to-device (D2D) communication, wireless backhaul, moving network, cooperative communication, coordinated multi-point (CoMP), and interference cancellation.

There are also other various schemes under development for the 5G system including, e.g., hybrid FSK and QAM modulation (FQAM) and sliding window superposition coding (SWSC), which are advanced coding modulation (ACM) schemes, and filter bank multi-carrier (FBMC), non-orthogonal multiple access (NOMA) and sparse code multiple access (SCMA), which are advanced access schemes.

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. To implement the IoT, technology elements, such as a sensing technology, wired/wireless communication and network infra, service interface technology, and a security technology, are required. There is a recent ongoing research for inter-object connection technologies, such as the sensor network, Machine-to-Machine (M2M), or the Machine-Type Communication (MTC). In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of existing information technology (IT) techniques and various industries.

Thus, there are various ongoing efforts to apply the 5G communication system to the IoT network. For example, the sensor network, machine-to-machine (M2M), machine type communication (MTC), or other 5G communication techniques are implemented by schemes, such as beamforming, multi-input multi-output (MIMO), and array antenna schemes. The above-mentioned application of the cloud radio access network (RAN) as a Big data processing technique may be said to be an example of the convergence of the 5G and IoT technologies.

### DETAILED DESCRIPTION OF THE INVENTION

### Technical Problem

A split rendering scheme may include a scheme in which a rendering process which is to be performed by a terminal (or user equipment (UE)) is performed by another device, e.g., by a server instead of the UE, and transmits a rendering result according to the rendering process to the UE. In the split rendering scheme, for the server to perform the rendering process, information about the content which is the target on which the rendering process is to be performed, as well as viewpoint information (e.g., pose or field of view) transmitted from the UE is required. The content before the rendering process is performed has the non-realtime property in which it may be always used by multiple unspecified users such as educational materials. However, since the results rendered after the rendering process is performed are valid only at a specific spatial position (e.g., a specific spatial position of the UE), a one-to-one relationship may be established between the UE and the server, it is content for one-time use and may not be reused by the UE and other UEs, and be generated and transferred in real-time to be transferred and consumed within several ms to several tens of ms.

To enable the UE to use a split rendering service in the communication system, a need arises for a method for controlling the processing load between the UE and the server.

### Technical Solution

According to an aspect of the disclosure, there may be provided a method and device for providing adaptive split rendering in a communication system.

According to another aspect of the disclosure, there may be provided a method and device for sharing data and related information between a UE and a server for adaptive split rendering in a communication system.

According to an aspect of the disclosure, there may be provided a method and device for controlling the processing load between a UE and a server for adaptive split rendering in a communication system.

According to an aspect of the disclosure, a method performed by a user equipment (UE) in a communication system may comprise receiving, from an application provider (AP) device, an adaptive split rendering (ASR) policy applied by the AP device, transmitting a service access information (SA) request for service access information (SAI) to an application function (AF) device based on the above ASR policy, receiving, from the AF device, a media play entry (MPE) uniform resource locator (URL) response including an MPE in response to the SAI request, transmitting an MPE request for the MPE to an adaptive split rendering signaling server (ASRSS) based on the MPE URL response, and receiving, from the ASRSS, an adaptive split rendering media play entry (ASRMPE) including a session description protocol (SDP) for 5th generation media streaming (5GMS) communication and a media presentation description (MPD) for web real-time communication (WebRTC) in response to the MPE request.

According to an aspect of the disclosure, a UE in a communication system may comprise a transceiver, and a processor connected to the transceiver. The processor may be configured to receive, through the transceiver from an application provider (AP) device, an adaptive split rendering (ASR) policy applied by the AP device, transmit, through the transceiver, a service access information (SAT) request for service access information (SAI) to an application function (AF) device based on the above ASR policy, receive, through the transceiver from the AF device, a media play entry (MPE) uniform resource locator (URL) response including an MPE in response to the SAT request, transmit, through the transceiver, an MPE request for the MPE to an adaptive split rendering signaling server (ASRSS) based on the MPE URL response, and receive, through the transceiver from the ASRSS, an adaptive split rendering media play entry (ASRMPE) including a session description protocol (SDP) for 5th generation media streaming (5GMS) communication and a media presentation description (MPD) for web real-time communication (WebRTC) in response to the MPE request.

### BRIEF DESCRIPTION OF DRAWINGS

FIG. 1 is a view illustrating a communication system according to an embodiment of the disclosure;

FIG. 2 is a view schematically illustrating a structure of a communication system according to an embodiment of the disclosure;

FIG. 3 is a signal flowchart schematically illustrating a service provision operation performed between an AF entity and an AP entity in a communication system according to an embodiment of the disclosure;

FIG. 4 is a view schematically illustrating an SRM profile list according to an embodiment of the disclosure;

FIG. 5 is a signal flowchart schematically illustrating an operation of providing content based on adaptive split rendering in a communication system according to an embodiment of the disclosure;

FIG. 6 is a view schematically illustrating an example of a structure of a network entity according to an embodiment of the disclosure;

FIG. 7 is a view schematically illustrating an example of a structure of a UE according to an embodiment of the disclosure;

FIG. 8 is a block diagram schematically illustrating another example of a structure of a UE according to an embodiment of the disclosure; and

FIG. 9 is a block diagram schematically illustrating another example of a structure of a network entity according to an embodiment of the disclosure.

### MODE FOR CARRYING OUT THE INVENTION

Hereinafter, an embodiment of the disclosure is described with reference to the accompanying drawings.

In describing the disclosure, the description of technologies that are known in the art and are not directly related to the present invention is omitted. This is for further clarifying the gist of the present disclosure without making it unclear. The terms as used herein are defined considering the functions in the present disclosure and may be replaced with other terms according to the intention or practice of the user or operator. Therefore, the terms should be defined based on the overall disclosure.

For the same reasons, some elements may be exaggerated or schematically shown. The size of each element does not necessarily reflects the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification. When determined to make the subject matter of the present invention unclear, the detailed description of the known art or functions may be skipped. The terms as used herein are defined considering the functions in the present disclosure and may be replaced with other terms according to the intention or practice of the user or operator. Therefore, the terms should be defined based on the overall disclosure.

Hereinafter, a base station (BS) is an entity that performs resource allocation of a UE, and may be at least one of a gNode B, eNode B, Node B, (or xNode B (where x is an alphabetic character including g and e)), a radio access unit, a base station controller, a satellite, an airborne, or a node on network. The user equipment (UE) may include a mobile station (MS), vehicle, satellite, airborne, cellular phone, smartphone, computer, or multimedia system capable of performing communication functions. In the disclosure, downlink (DL) refers to a wireless transmission path of signal transmitted from the base station to the terminal, and uplink (UL) refers to a wireless transmission path of signal transmitted from the terminal to the base station. Additionally, a sidelink (SL) meaning a radio transmission path of a signal transmitted from a UE to another UE may exist.

Although LTE, LTE-A, or 5G systems may be described below as an example, the embodiments may be applied to other communication systems having a similar technical background or channel pattern. For example, embodiments of the disclosure may also encompass 5G-advance or NR-advance or 6th generation mobile communication technology (6G) developed after 5G mobile communication technology (or new radio, NR). The following 5G may be a concept encompassing the legacy LTE. LTE-A and other similar services. Further, the embodiments may be modified in such a range as not to significantly depart from the scope of the present invention under the determination by one of ordinary skill in the art and such modifications may be applicable to other communication systems.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments, a “ . . . unit” may include one or more processors.

Wireless communication systems evolve beyond voice-centered services to broadband wireless communication systems to provide high data rate and high-quality packet data services, such as 3rd generation partnership project (3GPP) high speed packet access (HSPA), long term evolution (LTE) or evolved universal terrestrial radio access (E-UTRA)), LTE-advanced (LTE-A), LTE-pro, 3GPP2 high rate packet data (HRPD), ultra mobile broadband (UMB), and institute of electrical and electronics engineers (IEEE) 802.16e communication standards.

As a representative example of such broadband wireless communication system, the LTE system adopts orthogonal frequency division multiplexing (OFDM) for downlink and single carrier frequency division multiple access (SC-FDMA) for uplink. Uplink means a wireless link where the UE transmits data or control signals to the base station, and download means a wireless link where the base station transmits data or control signals to the UE. Such multiple access scheme may typically allocate and operate time-frequency resources carrying data or control information per user not to overlap, i.e., to maintain orthogonality, to thereby differentiate each user's data or control information.

Post-LTE communication systems, e.g., 5G communication systems, are required to freely reflect various needs of users and service providers and thus to support services that simultaneously meet various requirements. Services considered for 5G communication systems include, e.g., enhanced mobile broadband (eMBB), massive machine type communication (MMTC), and ultra reliability low latency communication (URLLC).

eMBB aims to provide a further enhanced data transmission rate as compared with LTE, LTE-A, or LTE-pro. For example, eMBB for 5G communication systems needs to provide a peak data rate of 20 Gbps on download and a peak data rate of 10 Gbps on uplink in terms of one base station. 5G communication systems also need to provide an increased user perceived data rate while simultaneously providing such peak data rate. To meet such requirements, various transmit (TX)/receive (RX) techniques, as well as multiple input multiple output (MIMO), need to further be enhanced. While LTE adopts a TX bandwidth up to 20 MHz in the 2 GHz band to transmit signals, the 5G communication system employs a broader frequency bandwidth in a frequency band ranging from 3 GHz to 6 GHz or more than 6 GHz to meet the data rate required for 5G communication systems.

mMTC is also considered to support application services, such as internet of things (IoT) in the 50 communication system. To efficiently provide IoT, mMTC is required to support massive UEs in the cell, enhance the coverage of the UE and the battery time, and reduce UE costs. IoT terminals are attached to various sensors or devices to provide communication functionality, and thus, it needs to support a number of UEs in each cell (e.g., 1,000,000 UEs/km²). Since mMTC-supportive UEs, by the nature of service, are highly likely to be located in shadow areas not covered by the cell, such as the underground of a building, it may require much broader coverage as compared with other services that the 5G communication system provides, mMTC-supportive UEs, due to the need for being low cost and difficulty in frequently exchanging batteries, may be required to have a very long battery life, e.g., 10 years to 15 years.

URLLC is a mission-critical, cellular-based wireless communication service. For example, URLLC may be considered for use in remote control for robots or machinery, industrial automation, unmanned aerial vehicles, remote health care, or emergency alert. This requires that URLLC provide very low-latency and very high-reliability communication. For example, URLLC-supportive services need to meet an air interface latency of less than 0.5 milliseconds simultaneously with a packet error rate of 10⁻⁵ or less. Thus, for URLLC-supportive services, the 5G communication system may be required to provide a shorter transmit time interval (TTI) than those for other services while securing reliable communication links by allocating a broad resource in the frequency band.

The three 5G services, i.e., eMBB, URLLC, and mMTC, may be multiplexed in one system and be transmitted. In this case, the services may adopt different TX/RX schemes and TX/RX parameters to meet their different requirements. Of course, 5G is not limited to the above-described three services.

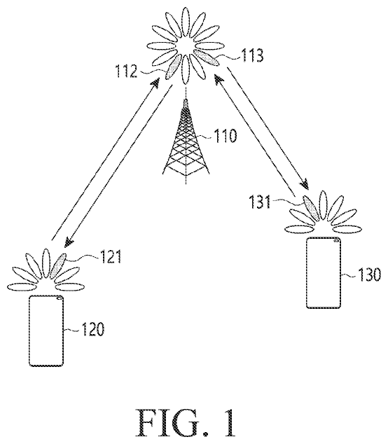

FIG. 1 is a view illustrating a communication system according to an embodiment of the disclosure.

FIG. 1 exemplifies a base station 110, a UE 120, and a UE 130 as some nodes using wireless channels in the communication system. Although only one base station is exemplarily illustrated in FIG. 1, other base stations identical or similar to the base station 110 may be further included.

Referring to FIG. 1, the base station 110 may be a network infrastructure that provides wireless access to the UEs 120 and 130. The base station 110 has a coverage defined as a predetermined geographic area based on an arrival distance within which it may transmit radio signals. The base station 110 may be denoted in other terms, such as an ‘access point (AP)’, an ‘eNodeB (eNB)’, a ‘gNodeB (gNB)’, a ‘5th generation (5G) node’, a ‘wireless point’, or a ‘transmission/reception point (TRP)’ or in other various terms with an equivalent technical meaning thereto.

Each of the UE 120 and the UE 130 is a device that may be used by the user and may perform communication with the base station 110 through a radio channel. In some cases, at least one of the UE 120 and the UE 130 may be operated without the user's involvement. In other words, at least one of the UE 120 and the UE 130 may be a device that performs machine type communication (MTC) and may not be carried by the user. Each of the UEs 120 and 130 may also be denoted by other terms, such as user equipment (UE), mobile station, subscriber station, remote terminal, wireless terminal, user device, or in other various terms with equivalent technical meanings thereto.

An embodiment of the disclosure may provide a method and device for providing adaptive split rendering in a communication system.

An embodiment of the disclosure may provide a method and device for providing an architecture and interface based on an architecture for 5th generation media streaming (5GMS) communication and an architecture for web real-time communication (WebRTC) in order to provide adaptive split rendering in a communication system.

An embodiment of the disclosure may provide a method and device for providing ARS service information including information related to the content to be provided by the service provider itself, the type of split rendering to be applied to the content, or the load of each UE and server to the 5GMS application function (AF) entity in order to provide adaptive split rendering in a communication system.

An embodiment of the disclosure may provide a method and device for providing a service by considering the 5GMS protocol and the WebRTC protocol together based on the service information received from the service provider in a communication system to provide adaptive split rendering.

An embodiment of the disclosure may provide a method and device for generating and providing an adaptive split rendering media play entry (ASRMPE) including a plurality of protocols and a plurality of adaptive split rendering profiles to a 5G UE based on service information received by the AF from a service provider in a communication system.

An embodiment of the disclosure may provide a method and device for providing seamless switching between media before the WebRTC re-negotiation process is performed and media after the WebRTC re-negotiation process is performed in the WebRTC re-negotiation process by an adaptive split rendering signaling server (ASRSS) in order to provide adaptive split rendering in a communication system.

First, an architecture that provides an adaptive split rendering scheme in a communication system and provides split-rendered media is described as follows. According to an embodiment, an architecture of a communication system providing an adaptive split rendering scheme may be based on an architecture for 5GMS communication and an architecture for WebRTC, and may provide an interface for providing an adaptive split rendering scheme.

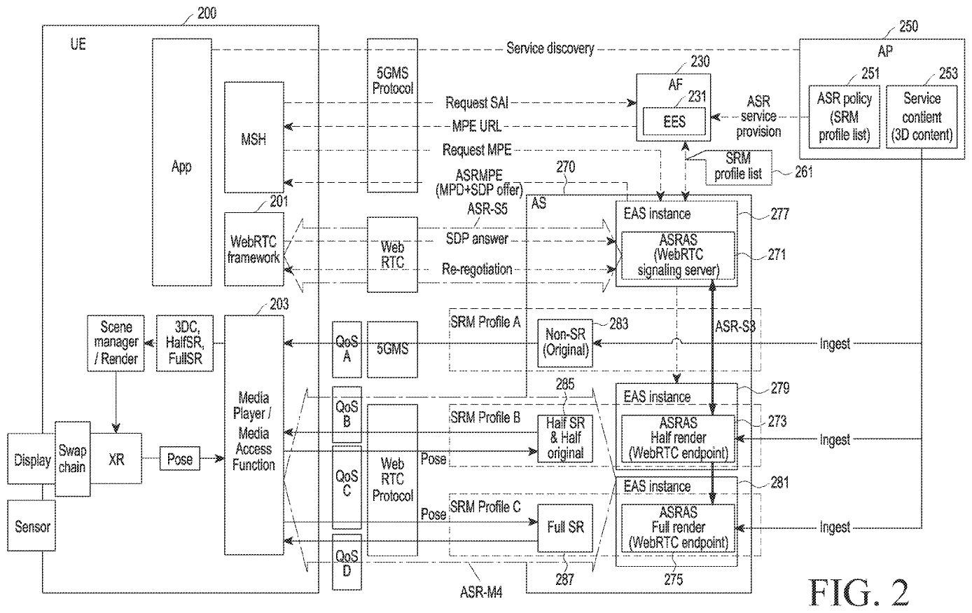

FIG. 2 is a view schematically illustrating a structure of a communication system according to an embodiment of the disclosure.

Referring to FIG. 2, a communication system may be based on an architecture for 5GMS communication. The communication system may include architectures for supporting other protocols, or communications based on other protocols, as well as the architecture for the 5GMS communication. The communication system may provide the function of 5GMS communication using other protocols as well as the existing protocols (e.g., dynamic adaptive streaming over hypertext transfer protocol (HTTP) and/or HTTP) supported in 5GMS communication.

The architecture for 5GMS communication is an architecture discussed in the 3rd generation partnership project (3GPP) SA4 related to 5GMS communication, and the architecture for 5GMS communication is an architecture that provides media services (e.g., media streaming services). Hereinafter, it should be noted that the term “media” may be used interchangeably with the term “content” for convenience of description. HTTP and DASH, which are protocols available in 5GMS communication, may support one-to-many relationships, and thus may support streaming of reusable media for a plurality of undesignated UEs.

In DASH, media variations of various qualities for one original media may be generated in advance, and a manifest (e.g., media presentation description (MPD)), which is information used by the UE to access these media variations, may be generated and provided. However, in the split rendering scheme, one-time media may be generated at the request of the UE under a one-to-one relationship between the UE and the server, and the generated one-time media may be transmitted in real-time. Further, although downlink streaming and/or uplink streaming may be supported in 5GMS communication, uplink transmission of control information related to media subject to downlink streaming is not supported. Since uplink transmission of control information related to media subject to downlink streaming is not supported, it may not be possible to generate or change content based on real-time communication for the UE in 5GMS communication.

Further, WebRTC is a protocol for interactive services between UEs, and data may be transmitted and received between UEs in real-time, but data connection should be re-established after the data connection is terminated to perform data transmission and reception between UEs again. In other words, in WebRTC, a disconnection due to data connection reestablishment may occur. Further, WebRTC does not provide control information such as load and/or provision waiting time for each data to be transmitted because a standard network interface for connecting with edge processing provided by the communication system is not defined and only communication between UEs is considered.

Therefore, in the disclosure, to support generating or changing content based on real-time communication for the UE, there may be provided an architecture of a communication system based on an architecture for 5GMS communication and an architecture for WebRTC (e.g., based on a combination of architecture for 5GMS communication and architecture for WebRTC).

In the disclosure, in order to enable the UE to use the split rendering service in the communication system, a method of controlling a processing load between the UE and the server may be provided. In the disclosure, when the UE's performance decreases after the service start time, a change may be requested so that the level of the rendering load on the server side is higher at the time of re-negotiation compared to the level of the rendering load requested by the UE at the start time, and in the case, seamless switching may be provided between the content being received by the UE and the content to be received after renegotiation.

As illustrated in FIG. 2, a communication system may include entities related to 5GMS communication, entities related to WebRTC, and entities related to an edge application (EdgeApp).

According to an embodiment, the entities related to 5GMS communication may include UE 200 (e.g., the UE 120 or UE 130 of FIG. 1), an application function (AF) entity 230, and/or an application server (AS) 270.

According to an embodiment, the entities related to WebRTC may include a WebRTC framework 201, an ASRSS 271, an adaptive split rendering application server (ASRAS) half render 273, and/or an ASRAS full render 275.

According to an embodiment, the entities related to the EdgeApp may include an edge enabler server (EES) 231, an edge application server (EAS) instance 277, an EAS instance 279, and/or an EAS instance 281.

In 5GMS communication, the entities related to the EdgeApp may be included in the architecture of the communication system, so when the EES 231 is illustrated in the AF entity 230, it may mean that the AF 230 entity may function and serve as the EES 231. In an embodiment, the AF 230 entity and the EES 231 may share information therebetween even without a separate interface. Likewise, when the EAS is illustrated in the AS 270, it may mean that the AS 270 may function and serve as the EAS, and may thus generate EAS instances (e.g., EAS instance 277, EAS instance 279, and/or EAS instance 281).

According to an embodiment, each of the WebRTC signaling server and WebRTC endpoints, which are entities related to WebRTC, may be generated, initialized, and executed as an EAS instance. In FIG. 2, the WebRTC signaling server may be generated as an EAS instance 277, and WebRTC endpoints may be generated as an EAS instance 279 and an EAS instance 281.

According to an embodiment, from a WebRTC perspective, peer devices participating in peer-to-peer communication and a signaling server related to the peer devices may be the UE, split rendering processes operating as EAS instances, and a WebRTC signaling server operating as an EAS instance.

According to an embodiment, in the communication system, an interface between the WebRTC framework 201 included in the UE (or terminal) 200 and the ASRSS 271 (e.g., an interface for control communication) may be an adaptive split rendering signaling interface #5 (ASR-S5), an interface between the ASRSS 271 and the ASRAS 273 (e.g., an interface for control communication) may be an adaptive split rendering signaling interface #3 (ASR-S3), and an interface between the media player of the UE 200 and/or the media access function entity 203 and the ASRAS 275 (e.g., an interface for media communication) may be an adaptive split rendering media interface #4 (ASR-M4).

According to an embodiment, the UE 200 may include a WebRTC framework 201, which is an entity for WebRTC, along with a media session handler (MSH) 205, which is an entity for 5GMS communication. The media player and/or media access function entity 203 of 5GMS communication may be extended to support the WebRTC protocol. For example, when the protocol used to receive content (or media) is the 5GMS protocol, the media player and/or media access function entity 203 may request media data from the AS 270 using the 5GMS protocol and receive media data from the AS 270 in response to the request. For example, when the protocol used to receive content (or media) is the WebRTC protocol, the media player and/or media access function entity 203 may perform WebRTC re-negotiation procedure with the ASRSS 271, transmit data related to the UE 200, such as a pose, to the ASRASs 273 and 275 based on the result of performing the WebRTC re-negotiation procedure, and receive rendered result media data from the ASRASs 273 and 275.

In an embodiment of the disclosure, the service provider may provide service information including information related to the content (or media) to be provided by the service provider itself, the type of split rendering to be applied to the content, or the load of each UE and server to the AF entity 230. This is described below in detail.

The service provider may also be referred to as a service operator or an application provider (AP). In FIG. 2, the AP entity 250 may generate content and provide the generated content to the UE 200. According to an embodiment, the AP entity 250 may provide content that may be reproduced by UEs included in the communication system or content that may not be reproduced by the UEs. The AP entity 250 may provide a split rendering service considering UEs that may reproduce the content provided by the AP entity 250 and UEs that may not reproduce the content provided by the AP entity 250 among the UEs included in the communication system. The AP entity 250 may determine an allowable quality of split rendered media (SRM), which is content to which the split rendering scheme is applied. As such, the process in which the AP entity 250 transfers an adaptive split rendering (ASR) policy, i.e., the information related to the service to be provided by the AP entity 250 and the information related to the content to be provided by the AP entity 250, through an interface with the AF entity 230 to provide the split rendering service and determine the allowable quality of the SRM considering the UEs that may reproduce the content provided by the AP entity 250 and the UEs that may not reproduce the content provided by the AP entity 250 is referred to as an ASR service provision process. The AP entity 250 may designate a provisioning session type for a provisioning session that the AP entity 250 intends to provide in the ASR service provision process. In the case, the AP entity 250 may determine the direction of transmission to be “both” considering the characteristics of split rendering. In an embodiment, the direction of transmission may include downlink, uplink, and both. In an embodiment, the indicator indicating the direction of transmission may be implemented with, e.g., 2 bits, and downlink may be set to a first value (e.g., 00) (downlink=00), uplink may be set to a second value (e.g., 01 (uplink=01), and bidirectional may be set to a third value (e.g., 10) (both=10). In the ASR service provision process, information related to the service included in the ASR policy may include an SRM profile list, which is a result of a split rendering process that the AP entity 250 allows to be provided. In FIG. 2, the ASR policy may include the service content to be provided by the AP entity 250, whether to allow the split rendering process, which is a process of reprocessing the service content to be provided by the AP entity 250, and a profile list of each SRM specified when the split rendering process is allowed. In an embodiment, the SRM profile list may include at least one SRM profile, and each SRM profile may include media attribute information to be transferred to the UE, such as the strength or level of the load of the rendering process required by the UE or server (e.g., AS, ASRSS, or ASRAS), codec, resolution, or the like.

In an embodiment, the AP entity 250 may perform a service provision operation on the AF entity 230. Hereinafter, for convenience of description, the service provision operation performed by the AP entity 250 on the AF entity 230 is referred to as an ASR service provision operation. In an embodiment, the ASR service provision may be M1 provisioning. In general, the provisioning application programming interface (API) for the AP entity 250 to provide a service to the AF entity 230 supported only the downlink type or the uplink type as the provisioning session type. The provisioning session type indicates the direction of transmission (e.g., the transmission type), and the indicator indicating the provisioning session type may be a provisioningSessionType. However, as described above, according to an embodiment, the AP entity 250 may determine the direction of transmission as “both” considering the characteristics of split rendering. In an embodiment, the direction of transmission may include downlink, uplink, and both. In an embodiment, the provisioningSessionType, which is an indicator indicating the direction of the transmission, may be implemented as, e.g., 2 bits, and the downlink may be set to a first value (e.g., 00) (downlink=00), the uplink to a second value (e.g., 01 (uplink=01), and the both to a third value (e.g., 10) (both=10). According to an embodiment, both may represent a provision session type where the AP entity 250 receives data such as a pose or a user action from the UE 200, generates content in real-time based on the data received from the UE 200, and transmits the content to the UE 200.

The provisioningSessionType may be based on the definition of ServiceAccessInformation resource as illustrated in Table 1 below.

TABLE 1

| Property name | Type | Cardinality | Usage | Description | Applicability |
|---|---|---|---|---|---|
| provisioningSessionId | ResourceId | 1 . . . 1 | RO | Unique | All types |
| | | | | identification | |
| | | | | of the M1 | |
| | | | | Provisioning | |
| | | | | Session. | |
| provisioningSessionType | ProvisioningSessionType | 1 . . . 1 | RO | The type of | All types. |
| | | | | Provisioning | |
| | | | | Session. | |

In Table 1, the provisioningSessionType may be represented as illustrated in Table 2.

TABLE 2

| ProvisioningSessionType: | |
|---|---|
| anyOf: | |
| - | type: string |
| | enum: [DOWNLINK, UPLINK, BOTH] |
| - | type: string |
| | description: > |
| | This string provides forward-compatibility with future |
| | extensions to the enumeration but is not used to encode |
| | content defined in the present version of this API. |

Meanwhile, in order for the AP entity 250 to specify content protocol and content distribution to the AS 270 through the AF entity 230, the media ingest and publish (M2) protocol and media streaming (M4) protocol may be changed as follows. This is the same as the extension of M2 provisioning and M4 provisioning.

According to an embodiment, the protocol used to distribute (or provide) content in the communication system may further include a WebRTC protocol as well as DASH and HTTP. Therefore, the AP entity 250 may include WebRTC distribution indicating the WebRTC protocol in the content distribution protocol information and DistributionConfiguration provided to the AF entity 230. This may be represented as illustrated in Table 3.

TABLE 3

| | | |
|---|---|---|
| Description | Term identifier | Clause |

Content ingest protocols at interface M2d

| | | |
|---|---|---|
| HTTP pull-based content ingest protocol | urn:3gpp:5gms:content-protocol:http-pull-ingest | 8.2 |
| DASH-IF push-based content ingest protocol | urn:3gpp:5gms:content-protocol:dash-if-ingest | 8.3 |
| WebRTC push-based content distribution | urn:3gpp:5gms:content-protocol:webrtc-distribution | 8.4 |
| protocol | | |

Content egest protocols at interface M2u

Table 3 may represent a set of content protocols supported by 5GMS AS, i.e., the AS 270. As illustrated in Table 3, the AS 270 may support HTTP, DASH, and WebRTC protocols.

In Table 3. Clause 8.2 and Clause 8.3 may be illustrated in Tables 4 and 5 below.

TABLE 4
8.2 HTTP pull-based content ingest protocol
If IngestConfiguration.protocol is set to urn:3gpp.5gms:content-protocol:http-pull-ingest
in the Content Hosting Configuration, media resources shall be ingested by the
5GMSd AS using HTTP. The IngestConfiguration.pull property shall be set to True,
indicating that a Pull-based protocol is used. The IngestConfiguration. entryPoint
property shall point at the 5GMSd Application Provider's origin server and may indicate
the use of HTTPS. The IngestConfiguration.entryPoint shall not contain a path part.
When the 5GMSd AS receives a request for a media resource at interface M4d that
cannot be satisfied from its content cache, the request shall be transformed into a
corresponding HTTP GET request directed to the 5GMSd Application Provider's origin
server via interface M2d, using the abovementioned entryPoint property concatenated
with the mappedPath from the applicable path rewrite rule (if any) selected from
Distribution Configuration.PathRewriteRules and the leaf path element from the original
M4d request URL to construct the M2d request URL.

TABLE 5
8.3 DASH-IF push-based content ingest protocol
If IngestConfiguration.protocol is set to urn:3gpp:5gms:content-protocol:dash-if-ingest in
the Content Hosting Configuration, media resources shall be ingested by the
5GMSd AS as specified by the DASH-IF Live Media Ingest specification. The
IngestConfiguration.pull property shall be set to False, indicating that a Push-based
protocol is used. The IngestConfiguration.entryPoint property shall be set to the URL
that will be used to upload the DASH segments and MPD to the 5GMSd AS at interface
M2d. This entry point URL shall not contain a path: the path for the URL shall instead
be specified by the IngestConfiguration.path property.

According to an embodiment of the disclosure, a method performed by a UE may comprise receiving, from an application provider (AP) device, an adaptive split rendering (ASR) policy applied by the AP device.

According to an embodiment of the disclosure, the method may comprise transmitting a service access information (SAI) request for service access information (SAI) to an application function (AF) device based on the above ASR policy.

According to an embodiment of the disclosure, the method may comprise receiving, from the AF device, a media play entry (MPE) uniform resource locator (URL) response including an MPE in response to the SAI request.

According to an embodiment of the disclosure, the method may comprise transmitting an MPE request for the MPE to an adaptive split rendering signaling server (ASRSS) based on the MPE URL response.

According to an embodiment of the disclosure, the method may comprise receiving, from the ASRSS, an adaptive split rendering media play entry (ASRMPE) including a session description protocol (SDP) for 5th generation media streaming (5GMS) communication and a media presentation description (MPD) for web real-time communication (WebRTC) in response to the MPE request.

According to an embodiment of the disclosure, the method may comprise transmitting a dynamic adaptive streaming over hypertext transfer protocol (HTTP) (DASH) segment request to a DASH application server (AS) based on the ASRMPE.

According to an embodiment of the disclosure, the method may comprise receiving a DASH segment from the DASH AS in response to the DASH segment request.

According to an embodiment of the disclosure, the method may comprise transmitting an SDP response to the ASRSS based on the ASRMPE.

According to an embodiment of the disclosure, the method may comprise transmitting information related to the UE to an adaptive split rendering application server (ASRAS) based on the ASRMPE.

According to an embodiment of the disclosure, the method may comprise receiving real-time communication (RTC) streaming from the ASRAS in response to the information related to the UE.

According to an embodiment of the disclosure, information related to the UE may include at least one of pose information or field of view information.

According to an embodiment of the disclosure, the ASR policy may include first information related to a service provided from the AP device and second information related to content provided from the AP device.

According to an embodiment of the disclosure, the ASR policy may include a provisioning session type for a provisioning session provided from the AP device.

According to an embodiment of the disclosure, the provisioning session type may indicate the direction of transmission and may indicate one of downlink, uplink, or both supporting both the downlink and uplink.

According to an embodiment of the disclosure, the ASR policy may include a split rendered media (SRM) profile list allowed to be provided by the AP device.

According to an embodiment of the disclosure, the SRM profile list may include at least one SRM profile.

According to an embodiment of the disclosure, each of the at least one SRM profile may include attribute information about media to be transferred to the UE.

According to an embodiment of the disclosure, the attribute information about the media may include at least one of a strength or level of a load of a rendering process required by the UE, the ASRSS, or the ASRAS, a codec, or a resolution.

According to an embodiment of the disclosure, the SDP may include at least one of a time/startupDelay which is a first receivable time from the media request of the UE, a time/presentationDelay which is a maximum delay time required to be expected until a first frame is output when switching to a channel being provided, or a time/mtpDelay which is a time from a time of transmitting information related to the UE to a time of outputting a photon on a display of the UE.

According to an embodiment of the disclosure, the SDP may include at least one of a type/projection which is a projection type of split rendered media (SRM), a type/viewport which is a field of view in which the SRM displays, a type/attribute which is a content or information format of the SRM, or a type/render which is a renderer pipeline requested from the UE.

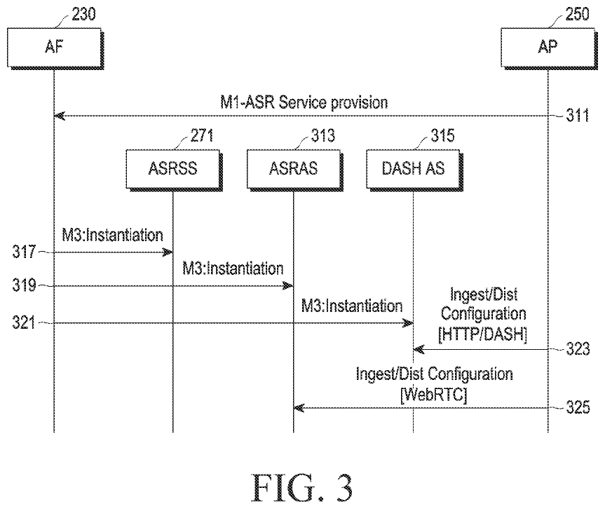

FIG. 3 is a signal flowchart schematically illustrating a service provision operation performed between an AF entity and an AP entity in a communication system according to an embodiment of the disclosure.

Referring to FIG. 3, the provisioning API for AP entity 250 (e.g., AP entity 250 of FIG. 2) to provide services to AF entity 230 (e.g., AF entity 230 of FIG. 2) supported only downlink type or uplink type as a provisioning session type.

However, according to an embodiment of the disclosure, the AP entity 250 may determine the direction of transmission as “both” considering the characteristics of split rendering. In an embodiment, the direction of transmission may include downlink, uplink, and both. In an embodiment, the provisioningSessionType, which is an indicator indicating the direction of the transmission, may be implemented as, e.g., 2 bits, and the downlink may be set to a first value (e.g., 00) (downlink=00), the uplink to a second value (e.g., 01 (uplink=01), and the both to a third value (e.g., 10) (both=10). Therefore, the AP entity 250 may set the direction of transmission through the ASR service provision operation in operation 311, which is similar to that described in Tables 1 and 2, and thus the detailed description thereof is omitted here.

The AF entity 230, which has been set for the direction of transmission through the ASR service provision operation by the AP entity 250, may request the ASRSS 271 (e.g., ASRSS 271 of FIG. 2), ASRAS 313, and DASH AS 315 in operations 317, 319, and 321, respectively, to perform an instantiation operation based on M3, which is an internal (M3) protocol.

The AP entity 250 that has performed an ASR service provision operation on the AF entity 230 may transmit an Ingest/Dist Configuration to the DASH AS 315 in operation 323. In operation 325, the AP entity 250 may transmit an Ingest/Dist Configuration indicating a set of content protocols supported by 5GMS AS, i.e., AS (e.g., AS 270 of FIG. 2) to the ASRAS 313. As described in Table 3, according to an embodiment, the AS may support the WebRTC protocol as well as HTTP and DASH.

According to an embodiment of the disclosure, the AP entity may provide ASR service information to the AF entity, and the AF entity may provide a service considering the 5GMS protocol and the WebRTC protocol simultaneously based on the ASR service information provided by the AP entity. The ASR service information may include information related to content to be provided by the AF entity, a type of split rendering to be applied to the content, or a load of each of the UE and the server.

According to an embodiment of the disclosure, the AF entity may generate an EAS instance for performing an ASRSS role and an EAS instance for each SRM profile according to whether the AP entity allows an ASR service. The EAS instance for the SRM profile serves as the ASRAS, and the EAS instance that serves as the ASRAS may be a WebRTC endpoint (e.g., the ASRAS half render 273 of FIG. 2 and/or the ASRAS full render 275) where the process for generating SRM corresponding to the SRM profile is executed.

Referring back to FIG. 2, ASR policy (SRM profile list) 251, service content (3D content) 253. SRM profile list 261, non-SR (original) content 283, half SR & half original content 285, and/or full SR content 287 may represent data.

The Non-SR content 283 may be content (e.g., media data) when the content provided by the AP entity 250 is provided as it is without going through a split rendering process.

The half SR & half original content 285 may be content when a split rendering process is applied to a portion of the content provided by the AP entity 250 and a split rendering process is not applied to the rest.

The full SR content 287 may be content provided after the split rendering process is applied to the entire content provided by the AP entity 250.

As described above, the Half SR&Half Original content 285 may be content generated when a split rendering process is applied only to a portion of the content provided by the AP entity 250. The range in which the split rendering process is applied to the content provided by the AP entity 250 and the processing level of the split rendering process may be implemented in a wide variety of forms, and thus a plurality of Half SR & Half Original contents 285 may be generated based on the range in which the split rendering process is applied to the content provided by the AP entity 250 and the processing level of the split rendering process.

In FIG. 2, assuming that the UE 200 performs complete split rendering processing, SRM profile A may transfer the service content (3D content) 253 of the AP entity 250 using the 5GMS media streaming function of the AS 270, so that no separate edge process is used, and the transmission protocol used for content transmission may be 5GMS.

Alternatively, the ASRAS half render 273 may be an edge process that generates SRM according to SRM profile B, and the ASRAS full render 275 may be an edge process that generates SRM according to SRM profile C. In the case, the protocol used for content transmission may be the WebRTC protocol, and thus the SRM profile B and SRM profile C may be transmitted using the WebRTC protocol.

According to an embodiment, based on the ASR service information, the AF entity may provide the UE (5G UE or UE) with an adaptive split rendering media play entry (ASRMPE) including a plurality of protocols and a plurality of ASR profiles.

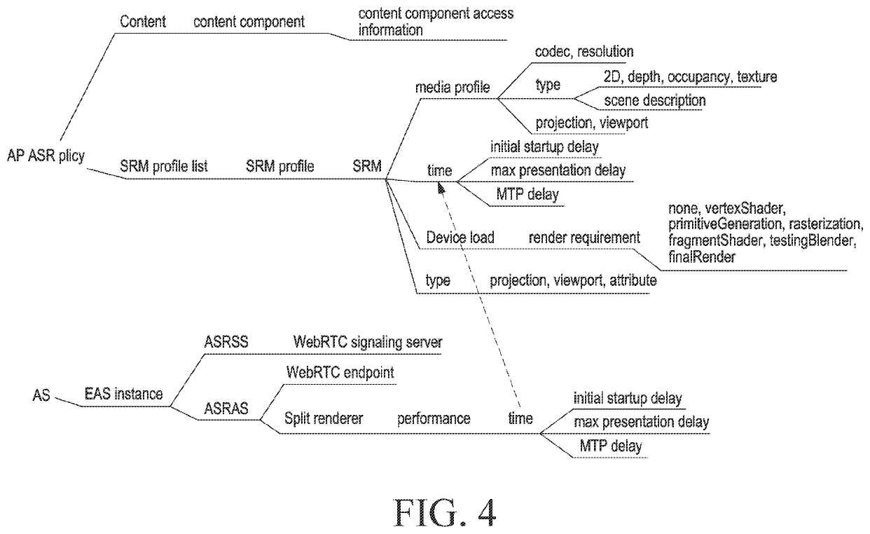

FIG. 4 is a view schematically illustrating an SRM profile list according to an embodiment of the disclosure.

Referring to FIG. 4, according to operations of ASRAS and ASRSS, the SRM profile list may include SRM profiles, and each SRM profile may provide SRM attribute information. The SRM attribute information may include media-related attribute information, time-related attribute information, performance-related attribute information, and/or UE component requirements.

As illustrated in FIG. 4, an AP ASR policy may include content and an SRM profile list. The content may include a content component, and the content component may include content component access information.

The SRM profile list may include an SRM profile, and the SRM profile may include SRM. The SRM may include a media profile, time, device load, and type. The media profile may include a codec, a resolution, a type, a projection, and a viewpoint. The type included in the media profile may include 2D, depth, occupancy, texture, and scene description. The time may include an initial startup delay, a maximum (max) presentation delay, and an MTP delay. The device load may include render requirements, and the render requirements may include none, vertexShader, primaryGeneration, raserization, framentShader, testingBlender, and finalRender. The type included in the SRM may include a projection, a viewpoint, and an attribute.

The SRM profile list may include a plurality of SRM profiles. Each SRM profile may provide attribute information about the SRM. The SRM attribute information may include media-related attribute information (e.g., media profile), time-related attribute information (e.g., time), performance-related attribute information (e.g., device load), and/or UE component requirements.

As illustrated in FIG. 4, an AS may include an EAS instance, and the EAS instance may include an ASRSS and an ASRAS. The ASRSS may include a WebRTC signaling server, and the ASRAS may include a WebRTC endpoint and a split renderer. The split renderer may include performance, the performance may include time, and the time may include an initial startup delay, a maximum (max) presentation delay, and an MTP delay.

According to an embodiment, in the communication system, the AF entity and the AS may simultaneously support the 5GMS protocol and the WebRTC protocol. Therefore, the process of searching for the content that the UE wants to receive starts based on the 5GMS protocol, but the reception of the split rendering service that the UE may request according to its performance or the SRM which is the result of the split rendering service may be provided through the 5GMS protocol or WebRTC protocol.

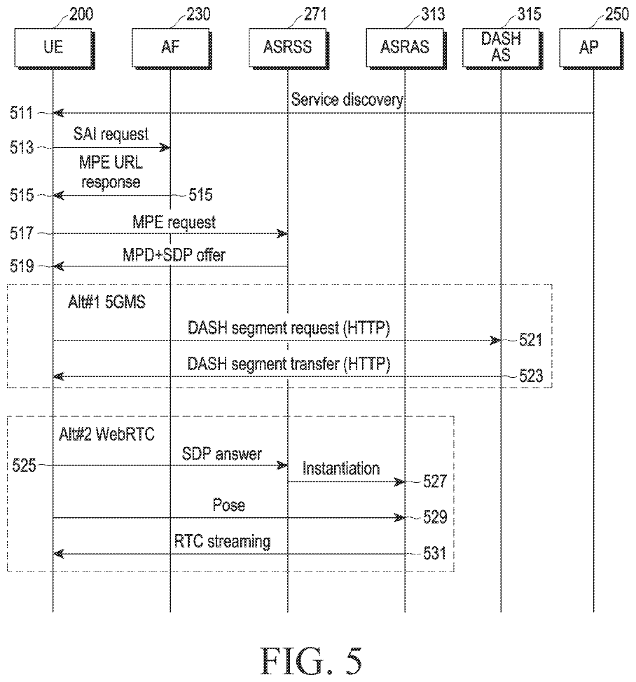

FIG. 5 is a signal flowchart schematically illustrating an operation of providing content based on adaptive split rendering in a communication system according to an embodiment of the disclosure.

Referring to FIG. 5, a communication system may include a UE (or terminal) 200 (e.g., the UE 200 of FIG. 2), an AF entity 230 (e.g., the AF entity 230 of FIG. 2 or 3), an ASRSS 271 (e.g., the ASRSS 271 of FIG. 2 or 3), an ASRAS 313 (e.g., the ASRAS 313 of FIG. 3), a DASH AS 315 (e.g., the DASH AS 315 of FIG. 3), and an AP entity 250 (e.g., the AP entity 250 of FIG. 2 or 3). In operation 511, an ASR service provision process may be performed through a service discovery procedure. After the ASR service provision process is performed, the AF entity 230 may generate the ASRSS 271 and the ASRAS 313 based on the SRM profile list. The ASRSS 271 may add or update the time attribute in the SRM profile list through performance measurement of the generated EAS instances. The AF entity 230 may receive a list of currently serviceable SRM profiles from the ASRSS 271, and may generate an ASRMPE based on the received SRM profile list.

In operation 513, the UE 200 may transmit an SAT request for service access information (SAI) to the AF entity 230 according to the 5GMS protocol. The AF entity 230 receiving the SAT request from the UE 200 may transmit a media play entry (MPE) uniform resource locator (URL) response including the MPE among the parameters included in the SAT to the UE 200 in operation 515.

The UE 200, which has received the MPE URL response from the AF entity 230, may transmit an MPE request for the MPE to the URL included in the received MPE URL response in operation 517. Upon receiving the MPE request from the UE 200, the ASRSS 271 may generate an ASRMPE in operation 519, and then transmit the generated ASRMPE to the UE 200 through an MPD+SDP offer. Parameters related to MPE included in the SAI may provide separate signaling for whether an ASR service is possible.

In an embodiment, the ASRMPE may be configured by a combination of an HTTP URL or DASH MPD for a 5GMS protocol and a session description protocol (SDP) for a WebRTC protocol. The SDP may be extended to describe the SRM profile included in the ASR policy, and a method of extending the SRM profile may be as follows.

First, the SDP extension is described as follows.

The SDP may use the “m:” line to specify the media, and use the “a:” line, which is described below, to provide attribute information for the media in the ml line.

Additional attribute information about the a line proposed in the disclosure may include the following.
time/startupDelay: This may mean a first receivable time, i.e., an initial start-up delay time, from a request (e.g., a media request of the UE).
time/presentationDelay: This may mean the maximum delay time required to be expected until the first frame is output when switching to the channel being provided (the maximum delay to show the first or dedicated frame after switching). Various parameters such as GoP, coding order, decoder buffer size, or the like may affect the time/presentationDelay.
time/mtpDelay: This may mean the time from the time of transmitting a pose by the UE to the time of outputting a photon on the display of the UE (MTP delay time between sending a pose and receiving a photon).

The additional attribute information as described above may be used as illustrated in Table 6 below.

TABLE 6
a=adaptiveSplitRendering time; startupDelay=100; maxPresentation
Delay=50; mtpDelay=10

The additional attribute information proposed in the disclosure may further include the following.
type/projection: This may mean the projection type of SRM. In an embodiment, the projection type may include various projection types such as 2D, cube, 360 or the like.
type/viewport: This may mean the field of view displayed by SRM.
type/attribute: This may mean the content or information format of SRM. In an embodiment, the content or information format of SRM may include image, depth, occlusion, alpha, or the like.
type/render: This may mean a renderer pipeline requested from the UE. The type/render may include none, vertexShader, primitiveGeneration, rasterization, fragmentShader, testingBlender, and finalRender. When a UE that does not support the pipeline receives the corresponding SRM, it may not be able to reproduce the received SRM or its performance may be decreased.

The additional attribute information as described above may be used as illustrated in Table 7 below.

TABLE 7
a=adaptiveSplitRendering type; projection=“2d”;viewportt=“horiz
ontal=20,vertical=10”;attribute=“depth”;render=“vertexShader,primitiveGeneration,raster
ization”

According to an embodiment, a detailed syntax of the ASRMPE may be as follows.

In an embodiment, the ASRMPE in HTTP URL format may be provided in the form of a list of URLs, and may include information related to the reception path of the original content that may be received using the 5GMS protocol from the AS (e.g., AS (270 of FIG. 2) and information related to the SDP offer reception path for communication with the ASRSS 271. The UE 200 may receive the ASRMPE from the ASRSS 271 through the MPD+SDP offer, and then perform a negotiation operation with the ASRSS 271, and receive SRM of a designated quality from the ASRAS 271 based on the result of the negotiation operation. After receiving the ASRMPE from the ASRSS 271 through the MPD+SDP offer, the UE 200 may transmit a DASH segment request to the DASH AS 315 in operation 521. The DASH AS 315 receiving the DASH segment request from the UE 200 may transmit a DASH segment to the UE 200 in response to the DASH segment request in operation 523. In an embodiment, the DASH segment request of operation 521 and the DASH segment transmission of operation 523 may be based on HTTP. In an embodiment, the DASH segment request transmission of operation 521 and the DASH segment transmission of operation 523 may be a content providing operation based on the 5GMS protocol.

In an embodiment, the ASRMPE in the DASH MPD format may be provided in the form of extending the function of the MPD by including the SDP in the MPD. For example, as the value of the schemeldUri attribute of @supplementalProperty, a uri, which indicates an extension for WebRTC communication of 5GMS of 3GPP may be used (e.g., urn:3gpp:contentProtocol:webrtc-distribution)), and the SDP may be included in the extensible markup language (XML) content below. After receiving the ASRMPE from the ASRSS 271 through the MPD+SDP offer, the UE 200 may receive original contents of various qualities through DASH, or perform a negotiation operation with the ASRSS 271 using the SDP included in the extension field, and receive SRM of the designated quality from the ASRAS 271 based on the result of the negotiation operation.

The MPD extension according to an embodiment may be described as follows.

The ASRMPE in the DASH MPD format may be provided in the form of extending the function of MPD by including SDP in the MPD. For example, the ASRMPE in DASH MPD format may be provided in the form of using uri, which indicates an extension for WebRTC communication of 5GMS of 3GPP, as a value of the schemeldUri attribute of @asupplementalProperty (e.g., urn:3gpp:contentProtocol:webrtc-distribution), and including the extended SDP in the following XML content.

After receiving the ASRMPE from the ASRSS 271 through the MPD+SDP offer, the UE 200 may transmit an SDP response to the ASRSS 271 in operation 525. The ASRSS 271 receiving the SDP response from the UE 200 may transmit an instantiation request to the ASRAS 313 in response to the SDP response in operation 527. Further, the UE 200 may transmit a pose to the ASRAS 313 in operation 529. In an embodiment, the pose may be data related to the UE 200. The ASRAS 313, which has received an instantiation request from the ASRSS 271 and the pose from the UE 200, may transmit RTC streaming to the UE 200 in operation 531. In an embodiment, the SDP response transmission in operation 525, the instantiation request transmission in operation 527, the pause transmission in operation 529, and the RTC streaming transmission in operation 531 may be content providing operations based on the WebRTC protocol.

According to an embodiment of the disclosure, the ASRSS may provide seamless switching between media before the WebRTC renegotiation process is performed and media after the WebRTC renegotiation process is performed. This may be described in detail as follows.

The ASRAS may continuously calculate the measured performance index of the process (e.g., 360VR rendering, stereoscopic rendering, and simplified scene description generation) according to the performance targeted at the time of self-evaluation or edge resource allocation request after generation and initialization, and may transfer the calculated measured performance index of the process to the ASRSS.

The measured performance index may be an index that may vary according to various parameters such as the performance of the server to which edge resources are allocated, the transmission speed of the cell to which the server belongs, the distance between the UE and the base station, the mobility speed, or the like. The AS may calculate the measured performance index based on network state, process performance measurement, or the like, and provide the calculated measured performance index as attribute information about SRM included in ASRMPE.

The measured performance index may include, e.g., initial start up delay time which is the time from the time of the UE's request and pose information ingest to the time of first transmitting the SRM which is the result of split rendering process, the max presentation delay time which is the maximum delay time when the first presentation is possible from the decoded picture buffer when the transmitted SRM is received and reproduced at any intermediate time, and motion to photon (MTP) delay time information that is supportable by, e.g., motion estimation, late stage reprojection (LSR) or time warp in the split rendering process.

For example, the operation in which the AF entity generates an EAS instance for the ASRAS may include an operation of determining which SRM is to be used as a result of the negotiation operation between the UE (or terminal) and the ASRSS and generating an EAS instance for providing the determined SRM(s) (hereinafter, referred to as a “first EAS instance generation operation” for convenience of description) and/or an operation in which the AF entity generates an EAS instance for each of all the SRMs in the process of generating the ASRSS and the ASRAS (hereinafter, referred to as a “second EAS instance generation operation” for convenience of description). According to an embodiment, the initial start up delay time may be the time until the generation and initialization, and processing results of the EAS instance are obtained in the first EAS instance generation operation and, in the second EAS instance generation operation, may be the time until the processing results are obtained after receiving the pose in the process preparation state.

The measured performance index may be inserted as attribute information for each SRM included in the ASRMPE generated by the ASRSS, and may be used as information for determining whether the UE selects the corresponding SRM in the WebRTC negotiation and renegotiation operation between the UE and the ASRSS.

The UE may determine whether to select the following SRM based on various time information (e.g., initial start up delay time, max presentation delay time, motion to photon delay time).

First, the UE may determine whether to receive SRM with lower complexity (e.g., lower complexity than currently provided complexity, or having a level smaller than a threshold complexity level) according to the UE's own state (e.g., a state expected to enter low power mode). If a lower complexity is allowed for the UE, the server generally requires a higher complexity (e.g., higher complexity than the complexity currently provided, or a complexity having a level equal to or higher than the threshold complexity level) and, in this case, the delay in performing higher-complexity processes on the edge resources of the server, network state-based delay or reduction time for transmitting higher or lower transmission amounts of SRMs, and MTP time of different SRMs may be factors to consider in the change.

Since a plurality of EAS instances have been generated for seamless switching between the SRM (e.g., the first SRM) being currently received by the UE and the SRM (e.g., the second SRM) to be received by the UE, the UE may select an EAS instance (second EAS instance) providing an appropriate SRM in addition to the EAS instance (e.g., first EAS instance) providing the SRM being currently received through communication with the ASRSS, get the second EAS instance ready during the operation of the first EAS instance and, after the reception of the second EAS instance starts, stop the first EAS instance.

Considering the time when the reception from the second EAS instance is started after a request for the second EAS instance, the max delay when switching between the first SRM and the second SRM after the reception from the second EAS instance is started, and the MTP delay of the second SRM which may differ from the first SRM, the UE may start the reception of the second SRM based on a time room reversely calculated from the target SRM switching time and, at the time when the reception of the first SRM and the reception of the second SRM overlap, connect the swap chain so that the respective target display times of the SRMs are contiguous to each other, and terminate the reception of the first SRM.

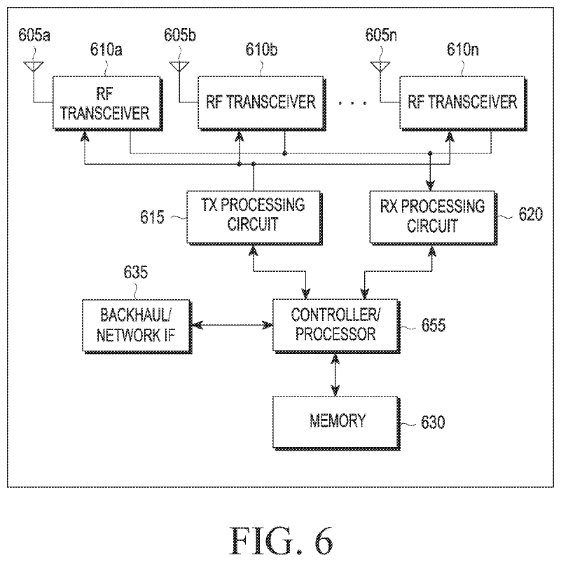

A structure of a network entity according to an embodiment is described below with reference to FIG. 6. The network entity (or network device (e.g., base station, AF entity, AP entity, or AS)) may be any one of various entities included in a communication system (e.g., mobile communication network).

FIG. 6 is a view schematically illustrating an example of a structure of a network entity according to an embodiment of the disclosure.

The embodiment of the network entity illustrated in FIG. 6 is for illustrative purposes only, and FIG. 6 does not limit the scope of the disclosure to any specific implementation of the network entity.

Referring to FIG. 6, the network entity includes a plurality of antennas 605a to 605n, a plurality of radio frequency (RF) transceivers 610a to 610n, a transmit (TX) processing circuit 615, and a receive (RX) processing circuit 620. The network entity further includes a controller/processor 625, memory 630, and a backhaul or network interface 635.

The RF transceivers 610a to 610n receive input RF signals, such as signals transmitted from UEs in the network, through the antennas 605a to 605n. The RF transceivers 610a to 610n down-convert the input RF signals, generating intermediate frequency (IF) or baseband signals. The IF or baseband signals are transmitted to the RX processing circuit 620, and the RX processing circuit 620 filters, decodes, and/or digitizes the baseband or IF signals, generating processed baseband signals. The RX processing circuit 620 sends the processed baseband signals to the controller/processor 625 for further processing.

The TX processing circuit 615 receives analog or digital data, such as speech data, web data, emails, or interactive video game data, from the controller/processor 625. The TX processing circuit 615 encodes, multiplexes, and/or digitizes the output baseband data, generating processed baseband or IF signals. The RF transceivers 610a to 610n receive the processed baseband or IF signals output from the TX processing circuit 615 and up-convert the baseband or IF signals into RF signals which are to be transmitted through the antennas 605a to 605n.

The controller/processor 625 may include one or more processors or other processing devices that control the overall operation of the network entity. In one example, the controller/processor 625 may control reception of forward channel signals and transmission of reverse channel signals by the RF transceivers 610a to 610n, the processing circuit 620, and the TX processing circuit 615 according to known principles. The controller/processor 625 may support additional functions, such as more advanced wireless communication functions.

In various embodiments of the disclosure, the controller/processor 625 performs the overall operation related to adaptive split rendering.

Further, the controller/processor 625 may support beamforming or directional routing operations in which signals output from the plurality of antennas 605a to 605n are differently weighted to efficiently steer the signals output in a desired direction. Any of other various functions may be supported by the controller/processor 625 in the network entity.

The controller/processor 625 may also execute programs and other processes, e.g., operating system (OS), resident in the memory 630. The controller/processor 625 may move data as required by a running process to the memory 630 or the outside of the memory 630.

The controller/processor 625 is connected with the backhaul or network interface 635. The backhaul or network interface 635 allows the network entity to communicate with other devices or systems over a backhaul connection or over a network. The interface 635 may support communications over any appropriate wired or wireless connection(s). For example, when the network entity is implemented as a part of a cellular communication system (such as a cellular communication system supporting 5G, LTE, or LTE-A), the interface 635 allows the network entity to communicate with other network entities via a wired or wireless backhaul connection. When the network entity is implemented as an access point, the interface 635 allows the network entity to communicate with a larger network (e.g., the Internet) via a wired or wireless local area network or a wired or wireless connection. The interface 635 includes an appropriate structure to support communications through a wired or wireless connection, such as Ethernet or RF transceiver.

The memory 630 is connected to the controller/processor 625. A portion of the memory 630 may include a random access memory (RAM), and another portion of the memory 630 may include a flash memory or a read-only memory (ROM).

Although FIG. 6 illustrates an example of a network entity, various changes may be made thereto. As an example, the network entity may include any number of such components as illustrated in FIG. 6. As a specific example, an access point may include a plurality of interfaces 635, and the controller/processor 625 may support routing functions to route data between different network addresses. As another specific example, although it is illustrated that a single instance of the TX processing circuit 615 and a single instance of the RX processing circuit 620 are included, the network entity may include a plurality of instances of each (like one for each RF transceiver). Various components of FIG. 6 may be combined together, or each component may be further divided or some components may be omitted or, as necessary, more components may be added.

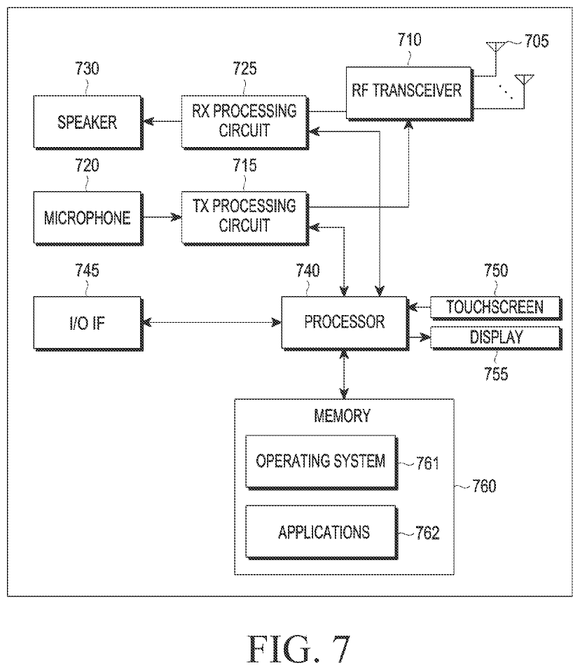

A structure of a UE according to an embodiment is described below with reference to FIG. 7.

FIG. 7 is a view schematically illustrating an example of a structure of a UE according to an embodiment of the disclosure.

The embodiment of the UE illustrated in FIG. 7 is for illustrative purposes only, and the scope of the disclosure is not limited thereto.

As illustrated in FIG. 7, the UE may include an antenna 705, a radio frequency (RF) transceiver 710, a transmit (TX) processing circuit 715, a microphone 720, and a receive (RX) processing circuit 725. The UE further includes a speaker 730, a processor 740, an input/output (I/O) interface (IF) 745, a touch screen 750, a display 755, and memory 760. The memory 760 includes an operating system (OS) 761 and one or more applications 762.

The RF transceiver 710 receives an input RF signal transmitted from a network entity in a network, via the antenna 705. The RF transceiver 710 down-converts the input RF signal, generating an intermediate frequency (IF) or baseband signal. The IF or baseband signal is transmitted to the RX processing circuit 725, and the RX processing circuit 725 filters, decodes, and/or digitizes the baseband or IF signal, generating a processed baseband signal. The RX processing circuit 725 sends the processed baseband signal to the speaker 730 (e.g., for speech data) or the processor 740 (e.g., for web browsing data) for further processing.

The TX processing circuit 715 receives analog or digital speech data from the microphone 720 or other output baseband data (e.g., web data, emails, or interactive video game data) from the processor 740. The TX processing circuit 715 encodes, multiplexes, and/or digitizes the output baseband data, generating a processed baseband or IF signal. The RF transceiver 710 receives the processed baseband or IF signal output from the TX processing circuit 715 and up-converts the baseband or IF signal into an RF signal which is to be transmitted through the antenna 705.

The processor 740 may include one or more processors or other processing devices, and may execute the OS 761 stored in the memory 760 to control the overall operation of the UE. As an example, the processor 740 may control reception of downlink channel signals and transmission of uplink channel signals by the RF transceiver 710, the RF processing circuit 725, and the TX processing circuit 715 according to known principles. In an embodiment, the processor 740 includes at least one microprocessor or microcontroller.

In an embodiment of the disclosure, the processor 740 performs the overall operation related to adaptive split rendering.

The processor 740 may execute other processes and programs embedded in the memory 760, such as processes related to adaptive split rendering. The processor 740 may move data into or out of the memory 760 as required by a running process. In an embodiment, the processor 740 is configured to execute the applications 762 based on the OS program 761 or in response to signals received from network entities or the operator. The processor 740 is coupled to the I/O interface 745, and the I/O interface 745 provides the UE with connectability to other devices, e.g., laptop computers and handheld computers. The I/O interface 745 is a communication path between these accessories and the processor 740.

The processor 740 is also connected to the touch screen 750 and the display unit 755. The operator of the UE may input data into the UE using the touch screen 750. The display 755 may be a liquid crystal display, a light emitting diode display, or other displays capable of rendering text and/or at least limited graphics, such as from websites.

The memory 760 is connected to the processor 740. A portion of the memory 760 may include a random access memory (RAM), and the remainder of the memory 760 may include a flash memory or a read-only memory (ROM).

Although FIG. 7 illustrates an example UE, various changes may be made thereto. For example, various components of FIG. 7 may be combined together, each component may be further divided, or some components may be omitted, or other components may be added as necessary. As an example, the processor 740 may be divided into multiple processors, such as one or more central processing units (CPUs) and one or more graphics processing units (GPUs). Although the UE is configured like a mobile phone or a smart phone in FIG. 7, the UE may be configured to operate as a different type of mobile or stationary device.

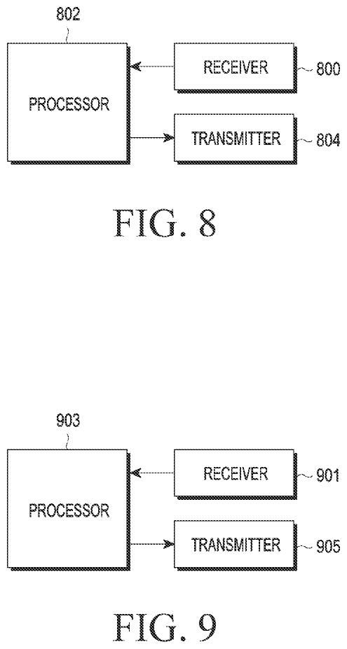

Another example of a structure of a UE according to an embodiment is described below with reference to FIG. 8.

FIG. 8 is a block diagram schematically illustrating another example of a structure of a UE according to an embodiment of the disclosure.

Referring to FIG. 8, the UE may include a receiver 800, a transmitter 804, and a processor 802. The receiver 800 and the transmitter 804 may collectively be referred to as a transceiver according to an embodiment of the disclosure. The transceiver may transmit/receive signals to/from the network entity. The signals may include control information and data. To that end, the transceiver may include an RF transmitter for frequency-up converting and amplifying transmitted signals and an RF receiver for low-noise amplifying and frequency-down converting received signals. The transceiver may receive signals via a radio channel, output the signals to the processor 802, and transmit signals output from the processor 802 via a radio channel. The processor 802 may control a series of processes for the UE to operate according to the above-described embodiments.

Another example of a structure of a network entity according to an embodiment of the disclosure is described below with reference to FIG. 9.

FIG. 9 is a block diagram schematically illustrating another example of a structure of a network entity according to an embodiment of the disclosure.

Referring to FIG. 9, the network entity may include a receiver 901, a transmitter 905, and a processor 903. The receiver 901 and the transmitter 905 may collectively be referred to as a transceiver according to an embodiment of the disclosure. The transceiver may transmit/receive signals to/from the UE. The signals may include control information and data. To that end, the transceiver may include an RF transmitter for frequency-up converting and amplifying transmitted signals and an RF receiver for low-noise amplifying and frequency-down converting received signals. The transceiver may receive signals via a radio channel, output the signals to the processor 903, and transmit signals output from the processor 903 via a radio channel. The processor 903 may control a series of processes for the network entity to operate according to the above-described embodiments of the disclosure.

According to an embodiment of the disclosure, a UE in a communication system may comprise a transceiver and a processor connected to the transceiver.

According to an embodiment of the disclosure, the processor may be configured to receive, through the transceiver from an application provider (AP) device, an adaptive split rendering (ASR) policy applied by the AP device.

According to an embodiment of the disclosure, the processor may be configured to transmit, through the transceiver, a service access information (SAI) request for service access information (SAI) to an application function (AF) device based on the above ASR policy.

According to an embodiment of the disclosure, the processor may be configured to receive, through the transceiver from the AF device, a media play entry (MPE) uniform resource locator (URL) response including an MPE in response to the SAI request.

transmit, through the transceiver, an MPE request for the MPE to an adaptive split rendering signaling server (ASRSS) based on the MPE URL response; and

According to an embodiment of the disclosure, the processor may be configured to receive, through the transceiver from the ASRSS, an adaptive split rendering media play entry (ASRMPE) including a session description protocol (SDP) for 5th generation media streaming (5GMS) communication and a media presentation description (MPD) for web real-time communication (WebRTC) in response to the MPE request.

According to an embodiment of the disclosure, the processor may be configured to transmit, through the transceiver, a dynamic adaptive streaming over hypertext transfer protocol (HTTP) (DASH) segment request to a DASH application server (AS) based on the ASRMPE.

According to an embodiment of the disclosure, the processor may be configured to receive, through the transceiver, a DASH segment from the DASH AS in response to the DASH segment request.

According to an embodiment of the disclosure, the processor may be configured to transmit, through the transceiver, an SDP response to the ASRSS based on the ASRMPE.

According to an embodiment of the disclosure, the processor may be configured to transmit, through the transceiver, information related to the UE to an adaptive split rendering application server (ASRAS) based on the ASRMPE.

According to an embodiment of the disclosure, the processor may be configured to receive, through the transceiver, real-time communication (RTC) streaming from the ASRAS in response to the information related to the UE.

According to an embodiment of the disclosure, information related to the UE may include at least one of pose information or field of view information.

According to an embodiment of the disclosure, the ASR policy may include first information related to a service provided from the AP device and second information related to content provided from the AP device.

According to an embodiment of the disclosure, the ASR policy may include a provisioning session type for a provisioning session provided from the AP device.

According to an embodiment of the disclosure, the provisioning session type may indicate the direction of transmission and may indicate one of downlink, uplink, or both supporting both the downlink and uplink.

According to an embodiment of the disclosure, the ASR policy may include a split rendered media (SRM) profile list allowed to be provided by the AP device.

According to an embodiment of the disclosure, the SRM profile list may include at least one SRM profile.

According to an embodiment of the disclosure, each of the at least one SRM profile may include attribute information about media to be transferred to the UE.

According to an embodiment of the disclosure, the attribute information about the media may include at least one of a strength or level of a load of a rendering process required by the UE, the ASRSS, or the ASRAS, a codec, or a resolution.

According to an embodiment of the disclosure, the SDP may include at least one of a time/startupDelay which is a first receivable time from the media request of the UE, a time/presentationDelay which is a maximum delay time required to be expected until a first frame is output when switching to a channel being provided, or a time/mtpDelay which is a time from a time of transmitting information related to the UE to a time of outputting a photon on a display of the UE.

According to an embodiment of the disclosure, the SDP may include at least one of a type/projection which is a projection type of split rendered media (SRM), a type/viewport which is a field of view in which the SRM displays, a type/attribute which is a content or information format of the SRM, or a type/render which is a renderer pipeline requested from the UE.

The embodiments herein are provided merely for better understanding of the present invention, and the present invention should not be limited thereto or thereby. In other words, it is apparent to one of ordinary skill in the art that various changes may be made thereto without departing from the scope of the present invention. Further, the embodiments may be practiced in combination. Although the disclosure has been described in connection with embodiments thereof, various changes or modifications may be made thereto and proposed to one of ordinary skill in the art. Such changes or modifications are intended as belonging to the scope of the appended claims. None of the elements, processes, or functions described herein should be interpreted as essential elements that should be included in the scope of the claims. The scope of the subject matter is defined by the claims.

1. A method performed by a user equipment (UE) in a communication system, the method comprising:
receiving, from an application provider (AP) device, an adaptive split rendering (ASR) policy applied by the AP device;
transmitting a service access information (SAI) request for service access information (SAI) to an application function (AF) device based on the above ASR policy;
receiving, from the AF device, a media play entry (MPE) uniform resource locator (URL) response including an MPE in response to the SAI request;
transmitting an MPE request for the MPE to an adaptive split rendering signaling server (ASRSS) based on the MPE URL response; and
receiving, from the ASRSS, an adaptive split rendering media play entry (ASRMPE) including a session description protocol (SDP) for 5th generation media streaming (5GMS) communication and a media presentation description (MPD) for web real-time communication (WebRTC) in response to the MPE request.

2. The method of claim 1, further comprising:
transmitting a dynamic adaptive streaming over hypertext transfer protocol (HTTP) (DASH) segment request to a DASH application server (AS) based on the ASRMPE; and
receiving a DASH segment from the DASH AS in response to the DASH segment request.

3. The method of claim 1, further comprising:
transmitting an SDP response to the ASRSS based on the ASRMPE;
transmitting information related to the UE to an adaptive split rendering application server (ASRAS) based on the ASRMPE; and
receiving real-time communication (RTC) streaming from the ASRAS in response to the information related to the UE.

4. The method of claim 1, wherein the ASR policy includes first information related to a service provided from the AP device and second information related to content provided from the AP device, and
wherein the ASR policy includes a provisioning session type for a provisioning session provided from the AP device.

5. The method of claim 1, wherein the SDP includes at least one of a time/startupDelay which is a first receivable time from the media request of the UE, a time/presentationDelay which is a maximum delay time required to be expected until a first frame is output when switching to a channel being provided, or a time/mtpDelay which is a time from a time of transmitting information related to the UE to a time of outputting a photon on a display of the UE.

6. The method of claim 1, wherein the SDP includes at least one of a type/projection which is a projection type of split rendered media (SRM), a type/viewport which is a field of view in which the SRM displays, a type/attribute which is a content or information format of the SRM, or a type/render which is a renderer pipeline requested from the UE.

7. A user equipment (UE) in a communication system, comprising:
a transceiver; and
a processor connected to the transceiver, wherein the processor is configured to:
receive, through the transceiver from an application provider (AP) device, an adaptive split rendering (ASR) policy applied by the AP device;
transmit, through the transceiver, a service access information (SAI) request for service access information (SAI) to an application function (AF) device based on the above ASR policy;
receive, through the transceiver from the AF device, a media play entry (MPE) uniform resource locator (URL) response including an MPE in response to the SAI request;
transmit, through the transceiver, an MPE request for the MPE to an adaptive split rendering signaling server (ASRSS) based on the MPE URL response; and
receive, through the transceiver from the ASRSS, an adaptive split rendering media play entry (ASRMPE) including a session description protocol (SDP) for 5th generation media streaming (5GMS) communication and a media presentation description (MPD) for web real-time communication (WebRTC) in response to the MPE request.

8. The UE of claim 7, wherein the processor is further configured to:
transmit, through the transceiver, a dynamic adaptive streaming over hypertext transfer protocol (HTTP) (DASH) segment request to a DASH application server (AS) based on the ASRMPE; and
receive, through the transceiver, a DASH segment from the DASH AS in response to the DASH segment request.

9. The UE of claim 7, wherein the processor is further configured to:
transmit, through the transceiver, an SDP response to the ASRSS based on the ASRMPE;
transmit, through the transceiver, information related to the UE to an adaptive split rendering application server (ASRAS) based on the ASRMPE; and
receive, through the transceiver, real-time communication (RTC) streaming from the ASRAS in response to the information related to the UE.

10. The UE of claim 9, wherein information related to the UE includes at least one of pose information or field of view information.

11. The UE of claim 7, wherein the ASR policy includes first information related to a service provided from the AP device and second information related to content provided from the AP device, and
wherein the ASR policy includes a provisioning session type for a provisioning session provided from the AP device.

12. The UE of claim 11, wherein the ASR policy includes a split rendered media (SRM) profile list allowed to be provided by the AP device.

13. The UE of claim 12, wherein the SRM profile list includes at least one SRM profile,
wherein each of the at least one SRM profile includes attribute information about media to be transferred to the UE, and
wherein the attribute information about the media includes at least one of a strength or level of a load of a rendering process required by the UE, the ASRSS, or the ASRAS, a codec, or a resolution.

14. The UE of claim 7, wherein the SDP includes at least one of a time/startupDelay which is a first receivable time from the media request of the UE, a time/presentationDelay which is a maximum delay time required to be expected until a first frame is output when switching to a channel being provided, or a time/mtpDelay which is a time from a time of transmitting information related to the UE to a time of outputting a photon on a display of the UE.

15. The UE of claim 7, wherein the SDP includes at least one of a type/projection which is a projection type of split rendered media (SRM), a type/viewport which is a field of view in which the SRM displays, a type/attribute which is a content or information format of the SRM, or a type/render which is a renderer pipeline requested from the UE.
